(19) United States
(12) Patent Application Publication
(10) Pub. No.: US 2026/0037829 A1
(43) Pub. Date: Feb. 5, 2026

(54) AUTOMATED EXECUTION OF USER-GENERATED REUSABLE WORKFLOWS

(71) Applicant: Express Scripts Strategic Development, Inc., St. Louis, MO (US)

(72) Inventors: Afroze Khan, Plano, TX (US); Ahmed Qureshi, Woodbridge, NJ (US); Subhasree Devendran, Tampa, FL (US); Anne Wei, Oakland, CA (US); Bhavya Shah, West Orange, NJ (US)

(21) Appl. No.: 18/792,747

(22) Filed: Aug. 2, 2024

(51) Int. Cl. G06N 3/0985

(52) U.S. Cl. CPC G06N 3/0985

(57) ABSTRACT

A method includes loading a first machine learning scheme, wherein the first scheme includes a set of data models, an assignment of a first set of values to a first feature, and a first set of tasks reliant on the set of data models and the set of features. The method includes implementing the first scheme. The method includes, in response to detecting user inputs, displaying user interface elements for modifying a saved scheme. The method includes, in response to detecting user inputs, modifying the first scheme. Modifying the first scheme includes modifying the first set of tasks and saving the tasks as a second set of tasks. The second set of tasks includes a task for generating an output data set via the set of data models. The method includes saving the modified first scheme as a second scheme, implementing the second scheme, and outputting the output data set.

### FIELD

The present disclosure relates to database query creation and more particularly to iterative formation of a database query and processing of query results.

### BACKGROUND

Data models such as a those used in machine learning or neural networks are useful tools for data analysis and prediction. However, the set up and use of such data models can be time intensive, often requiring specialized knowledge and training.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes loading a first scheme from a machine learning scheme repository. The first scheme includes a set of data models for evaluating a set of features including a first feature, an assignment of a first set of values to the first feature, and a first set of tasks reliant on the set of data models and the set of features. The method includes, in response to detecting a first set of user inputs corresponding to a request to implement the first scheme, implementing the first scheme by executing tasks of the first set of tasks. The method includes, in response to detecting a second set of user inputs, transforming a user interface to display a first set of user interface elements for modifying a saved scheme. The method includes, in response to detecting a third set of user inputs corresponding to the first set of user interface elements, loading the first scheme, displaying the first scheme via the first set of user interface elements, and modifying the first scheme according to the third set of user inputs. Modifying the first scheme includes modifying the first set of tasks and saving the modified first set of tasks as a second set of tasks. The second set of tasks includes a task for generating an output data set via the set of data models. The method includes saving the modified first scheme as a second scheme in the machine learning scheme repository. The method includes implementing the second scheme by executing tasks of a second set of tasks and outputting the output data set.

In other features, a plurality of tasks from the first set of tasks are completed in parallel. In other features, saving the second scheme is performed in response to receiving an indication of authorization. In other features, the first set of tasks includes at least one of a task for generating a population, a task for generating the set of features, a task for loading the set of features, a task for loading a set of configuration information, a task for performing a set of imputation actions for substituting missing data, a task for generating a set of predictions using the set of data models, or a task for generating a set of statistics about the set of predictions and the set of features.

In other features, generating features includes determining one or more values. In other features, the set of configuration information includes mapping the set of features to the first set of values in the set of data models. In other features, modifying the first scheme includes at least one of adding at least a first data model to the set of data models, removing at least a second data model from the set of data models, adding at least a second feature to the set of features, removing at least a third feature from the set of features, assigning a second set of values to the first feature, adding at least a first task to the first set of tasks, removing at least a second task from the first set of tasks.

In other features, the second set of tasks is different from the first set of tasks. In other features, outputting the output data set includes displaying the output data set via a second set of user interface elements. In other features, the assignment of the first set of values to the first feature includes at least one of a location of the first set of values in a data source, a parsing algorithm for identifying the first set of values, or a first data field in the data source.

A computer system comprises memory hardware configured to store instructions and processor hardware configured to execute the instructions stored in the memory hardware. The instructions include loading a first scheme from a machine learning scheme repository. The first scheme includes a set of data models for evaluating a set of features including a first feature, an assignment of a first set of values to the first feature, and a first set of tasks reliant on the set of data models and the set of features. The instructions include, in response to detecting a first set of user inputs corresponding to a request to implement the first scheme, implementing the first scheme by executing tasks of the first set of tasks. The instructions include, in response to detecting a second set of user inputs, transforming a user interface to display a first set of user interface elements for modifying a saved scheme. The instructions include, in response to detecting a third set of user inputs corresponding to the first set of user interface elements, loading the first scheme, displaying the first scheme via the first set of user interface elements, and modifying the first scheme according to the third set of user inputs. Modifying the first scheme includes modifying the first set of tasks and saving the modified first set of tasks as a second set of tasks. The second set of tasks includes a task for generating an output data set via the set of data models. The instructions include saving the modified first scheme as a second scheme in the machine learning scheme repository. The instructions include implementing the second scheme by executing tasks of a second set of tasks and outputting the output data set.

In other features, a plurality of tasks from the first set of tasks are completed in parallel. In other features, saving the second scheme is performed in response to receiving an indication of authorization. In other features, the first set of tasks includes at least one of a task for generating a population, a task for generating the set of features, a task for loading the set of features, a task for loading a set of configuration information, a task for performing a set of imputation actions for substituting missing data, a task for generating a set of predictions using the set of data models, or a task for generating a set of statistics about the set of predictions and the set of features.

In other features, generating features includes determining one or more values. In other features, the set of configuration information includes mapping the set of features to the first set of values in the set of data models. In other features, modifying the first scheme includes at least one of adding at least a first data model to the set of data models, removing at least a second data model from the set of data models, adding at least a second feature to the set of features, removing at least a third feature from the set of features, assigning a second set of values to the first feature, adding at least a first task to the first set of tasks, removing at least a second task from the first set of tasks.

In other features, the second set of tasks is different from the first set of tasks. In other features, outputting the output data set includes displaying the output data set via a second set of user interface elements. In other features, the assignment of the first set of values to the first feature includes at least one of a location of the first set of values in a data source, a parsing algorithm for identifying the first set of values, or a first data field in the data source.

A non-transitory computer-readable storage medium stores processor-executable instructions. The instructions include loading a first scheme from a machine learning scheme repository. The first scheme includes a set of data models for evaluating a set of features including a first feature, an assignment of a first set of values to the first feature, and a first set of tasks reliant on the set of data models and the set of features. The instructions include, in response to detecting a first set of user inputs corresponding to a request to implement the first scheme, implementing the first scheme by executing tasks of the first set of tasks. The instructions include, in response to detecting a second set of user inputs, transforming a user interface to display a first set of user interface elements for modifying a saved scheme. The instructions include, in response to detecting a third set of user inputs corresponding to the first set of user interface elements, loading the first scheme, displaying the first scheme via the first set of user interface elements, and modifying the first scheme according to the third set of user inputs. Modifying the first scheme includes modifying the first set of tasks and saving the modified first set of tasks as a second set of tasks. The second set of tasks includes a task for generating an output data set via the set of data models. The instructions include saving the modified first scheme as a second scheme in the machine learning scheme repository. The instructions include implementing the second scheme by executing tasks of a second set of tasks and outputting the output data set.

In other features, a plurality of tasks from the first set of tasks are completed in parallel. In other features, saving the second scheme is performed in response to receiving an indication of authorization. In other features, the first set of tasks includes at least one of a task for generating a population, a task for generating the set of features, a task for loading the set of features, a task for loading a set of configuration information, a task for performing a set of imputation actions for substituting missing data, a task for generating a set of predictions using the set of data models, or a task for generating a set of statistics about the set of predictions and the set of features.

In other features, generating features includes determining one or more values. In other features, the set of configuration information includes mapping the set of features to the first set of values in the set of data models. In other features, modifying the first scheme includes at least one of adding at least a first data model to the set of data models, removing at least a second data model from the set of data models, adding at least a second feature to the set of features, removing at least a third feature from the set of features, assigning a second set of values to the first feature, adding at least a first task to the first set of tasks, removing at least a second task from the first set of tasks.

In other features, the second set of tasks is different from the first set of tasks. In other features, outputting the output data set includes displaying the output data set via a second set of user interface elements. In other features, the assignment of the first set of values to the first feature includes at least one of a location of the first set of values in a data source, a parsing algorithm for identifying the first set of values, or a first data field in the data source.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a functional block diagram of example machine learning model training and usage.

FIG. 5 is a functional block diagram of an example neural network.

FIG. 6 is a functional block diagram of an example neural network.

FIG. 7 is a functional block diagram of an example long short-term memory neural network.

FIG. 8 is a functional block diagram of an example system for generating and implementing reusable workflows.

FIGS. 9A-9C are a flowchart of an example reusable workflow generation and implementation method.

In the drawings, reference numbers may be reused to identify similar and/or identical elements.

### DETAILED DESCRIPTION

### Introduction

The present disclosure describes generating and executing reusable workflows for machine learning data model analysis. In some implementations, an analyst user implements a machine learning scheme (or workflow) for data analysis via a graphical user interface. In some implementations, the machine learning scheme includes one or more data models, one or more tasks, one or more features, values assigned to the one or more features, data for analysis, analysis instructions, post processing steps (such as statistical analysis) and/or configuration data (e.g., feature mapping, imputation, metadata, data storage information, etc.) The scheme can be saved, executed, and updated as needed. In some implementations, the scheme can be used as a template and modified. The analyst user may wish to create a new scheme similar to an already existing scheme. Using the present disclosure, the analyst user need not create the new scheme from scratch, but can modify some or all elements of the previously saved scheme. Creating new schemes from a pre-existing scheme via a graphical user interface reduces the complexity of implementing the necessary rules. These features are related to those found in U.S. Application No. XXX filed XXX titled AUTOMATED POPULATION DEVELOPMENT FOR SEARCH QUERIES (Attorney Docket No. ESRX-429US1), the entire disclosure of which is incorporated by reference.

### High-Volume Pharmacy

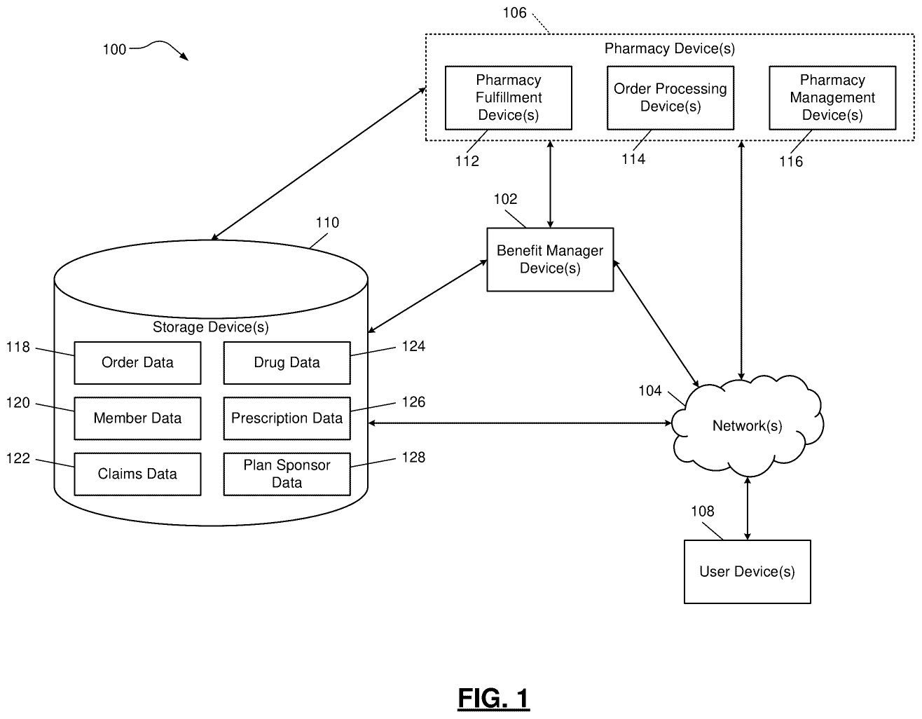

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However, in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include type of the prescription drug (for example, drug name and strength) and quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, age, date of birth, address (including city, state, and zip code), telephone number, e-mail address, medical history, prescription drug history, etc. In various implementations, the prescription drug history may include a prior authorization claim history—including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 120 may also include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. In various implementations, the member data 120 may include an eligibility period for each member. For example, the eligibility period may include how long each member is eligible for coverage under the sponsored plan. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member). In various implementations, the claims data 122 may include a percentage of prior authorization cases for each prescriber that have been denied, and a percentage of prior authorization cases for each prescriber that have been approved.

The drug data 124 may include drug name (e.g., technical name and/or common name), other names by which the drug is known, active ingredients, an image of the drug (such as in pill form), etc. The drug data 124 may include information associated with a single medication or multiple medications. For example, the drug data 124 may include a numerical identifier for each drug, such as the U.S. Food and Drug Administration's (FDA) National Drug Code (NDC) for each drug.

The prescription data 126 may include information regarding

prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

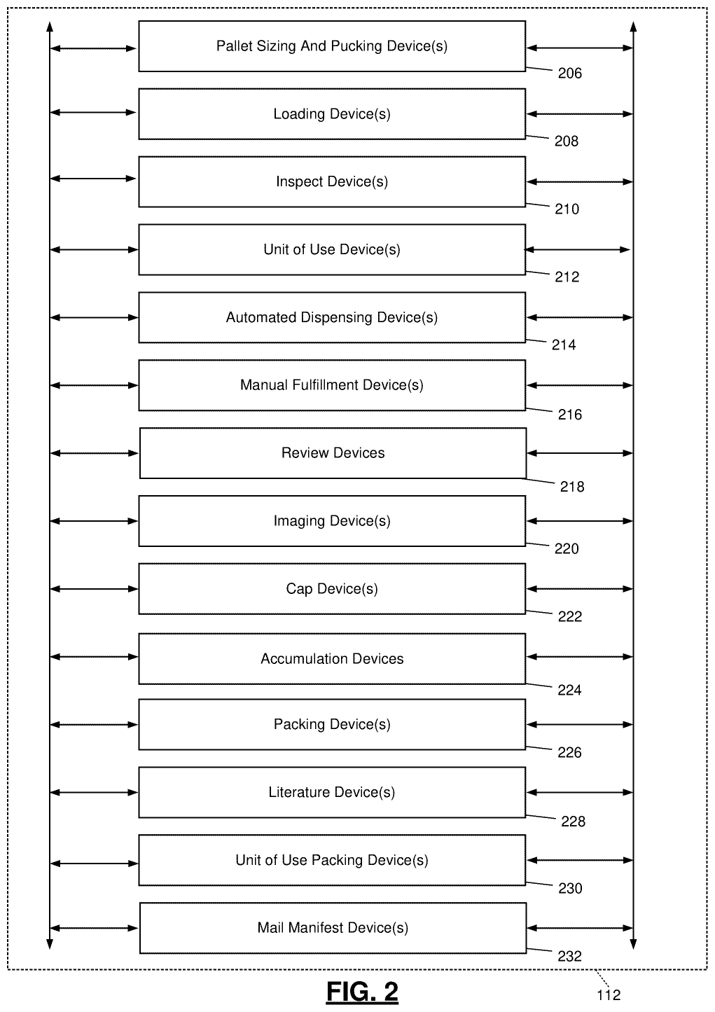

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

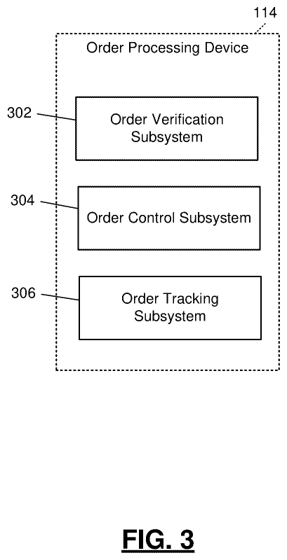

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors: for example, to deliver the pallet from the loading device 208 to the manual fulfillment device 216 from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Machine Learning Models

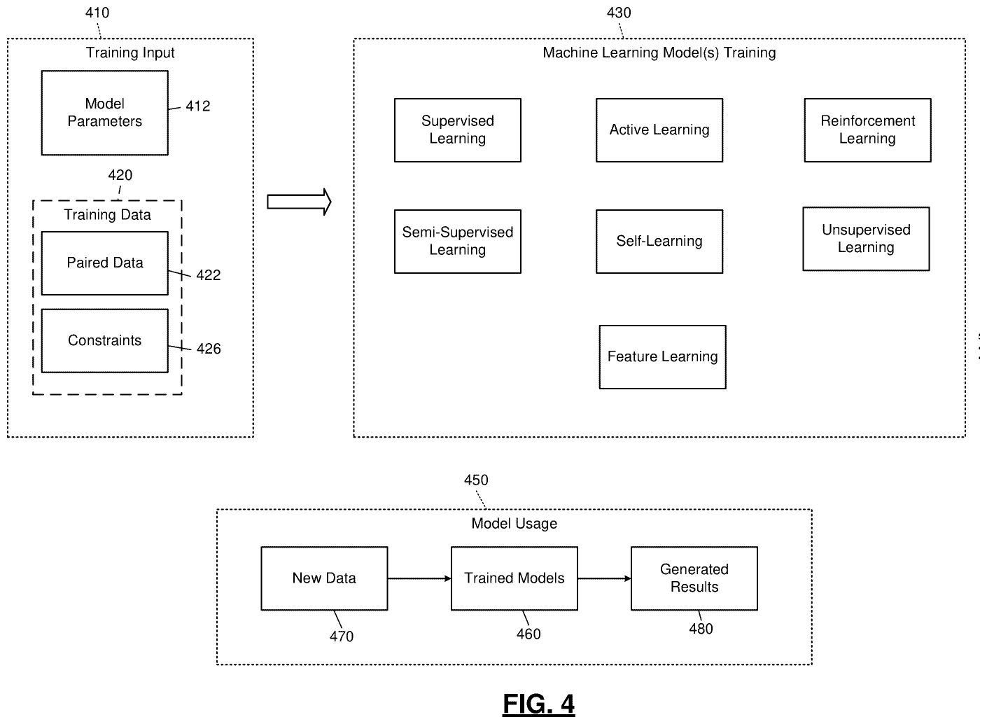

FIG. 4 is a block diagram of an example service that may be deployed above. Training input 410 includes model parameters 412 and training data 420, which may include paired training data sets 422 (e.g., input-output training pairs) and constraints 426. Model parameters 412 represents storing and/or providing the parameters or coefficients of corresponding ones of machine learning models. During training, the model parameters 412 are adapted based on the input-output training pairs of the training data sets 422. After the model parameters 412 are adapted (after training), the parameters are used in 450 by trained models 460 to implement the trained machine learning models on a new data 470.

Training data 420 optionally includes constraints 426 which may define the constraints of a given member's information features. The paired training data sets 422 optionally include sets of input-output pairs, such as pairs of a plurality of member preferences and features of entities associated with providers. Some components of training input 410 may be stored separately at a different off-site facility or facilities than other components.

Machine learning model(s) training 430 trains one or more machine learning techniques based on the sets of input-output pairs of paired training data sets 422. For example, the model training 430 may train the machine learning (ML) model parameters 412 by minimizing a loss function based on one or more ground-truth data. The model training 430 may include supervised learning, semi-supervised learning, active learning, self-learning, feature learning, reinforcement learning, and unsupervised learning.

The ML models can include any one or combination of classifiers or neural networks, such as an artificial neural network, a convolutional neural network, an adversarial network, a generative adversarial network, a deep feed forward network, a radial basis network, a recurrent neural network, a long/short term memory network, a gated recurrent unit, an auto encoder, a variational autoencoder, a denoising autoencoder, a sparse autoencoder, a Markov chain, a Hopfield network, a Boltzmann machine, a restricted Boltzmann machine, a deep belief network, a deep convolutional network, a deconvolutional network, a deep convolutional inverse graphics network, a liquid state machine, an extreme learning machine, an echo state network, a deep residual network, a Kohonen network, a support vector machine, a neural Turing machine, etc.

Particularly, a first ML model of the ML models can be applied to a training batch of member preferences to estimate or generate a prediction of provider choice for a particular member. In some implementations, a derivative of a loss function is computed based on a comparison of an estimate with ground truth entities, and parameters of the first ML model are updated based on the computed derivative of the loss function. The result of minimizing the loss function for multiple sets of training data trains, adapts, or optimizes the model parameters 412 of the corresponding first ML model. In this way, the first ML model is trained to establish a relationship between member data and member selections.

After the machine learning models are trained, new data 470, including one or more sets of features for members, are received and/or derived from a document being accessed from the storage device 110. The first trained machine learning model may be applied to the new data 470 to generate results 480 (such as a prediction).

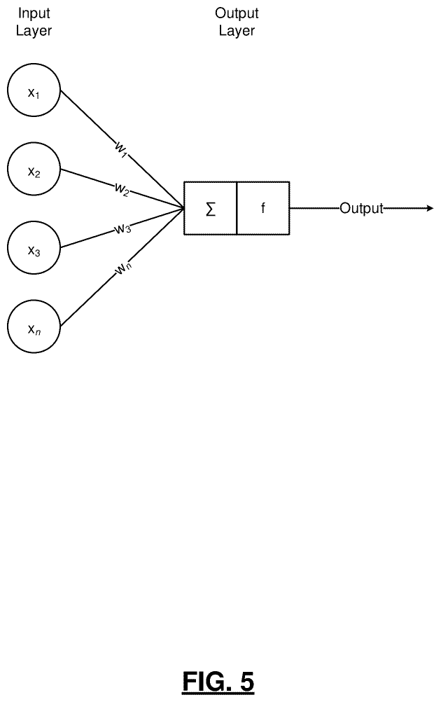

FIG. 5 is a graphical representation of an example neural network with no hidden layers for implementing a machine learning module. In machine learning, a neural network—or an artificial neural network—is a network or circuit of artificial neurons or nodes having at least an input layer and an output layer. In various implementations, neural networks may also have one or more hidden layers. Neural networks may be used in deep learning applications to allow computer systems to solve artificial intelligence problems—such as problems in predictive modeling, pattern recognition, and dynamic control systems.

FIG. 5 shows a neural network without any hidden layers. The neural network of FIG. 5 may also be referred to as a single-layer perceptron. The neural network of FIG. 5 is shown with an input layer including n nodes, labeled x₁, x₂, x₃, and xₙ. While only four nodes are illustrated in FIG. 5, the input layer may have any number of nodes. In various implementations, each node may represent any numerical value. For example, each node may represent a numerical value in a range of between 0 and 1. So, for example, the nodes of the input layer could be expressed in interval notation as: x₁∈[0,1], x₂∈[0,1], x₃∈[0,1], and xₙ∈[0,1]. In various implementations, the input variables to a neural network may be expressed as a vector i having n dimensions. In the example of FIG. 5, input vector i may be represented by equation (1) below:

$$i = 〈 {x}_{1} , {x}_{2} , {x}_{3} , {x}_{n} 〉 . \qquad ( 1 )$$

Each of the nodes may be multiplied by a weight—represented by w₁, w₂, w₃, and wₙ in FIG. 5—before being fed into a node in the next layer. In FIG. 5, because there are no hidden layers, the next layer is the output layer. For simplicity of illustration, only a single node is shown in the output layer of FIG. 5. However, the output layer may include any number of nodes.

At the node in the next layer, the inputs of the node are summed. Thus, because the inputs of the node in the output layer of FIG. 5 are the numerical value of each of the nodes of the previous layer multiplied by a weight, the summation Σ may be represented by equation (2) below:

$$\sum = {x}_{1} {w}_{1} + {x}_{2} {w}_{2} + {x}_{3} {w}_{3} + {x}_{n} {w}_{n} . \qquad ( 2 )$$

In various implementations, a bias b may be added to the nodes x of the previous layer after they have been multiplied by a weight w. For example, if biases b are added, then summation Σ may be represented by equation (3) below:

$$\sum = ( {x}_{1} {w}_{1} + {b}_{1} ) + ( {x}_{2} {w}_{2} + {b}_{2} ) + ( {x}_{3} {w}_{3} + {b}_{3} ) + ( {x}_{n} {w}_{n} + {b}_{n} ) \qquad ( 3 )$$

The summation Σ may then be fed into an activation function f. The activation function f may be any mathematical function suitable for calculating an output for the node. Example activation functions f may include linear or non-linear functions, step functions such as the Heaviside step function, derivative or differential functions, monotonic functions, sigmoid or logistic activation functions, rectified linear unit (ReLU) functions, and/or leaky ReLU functions. The output of the function fis then the output of the node. In a neural network with no hidden layers—such as the single-layer perceptron shown in FIG. 5—the output of the nodes in the output layer are the output variables or output vector of the neural network.

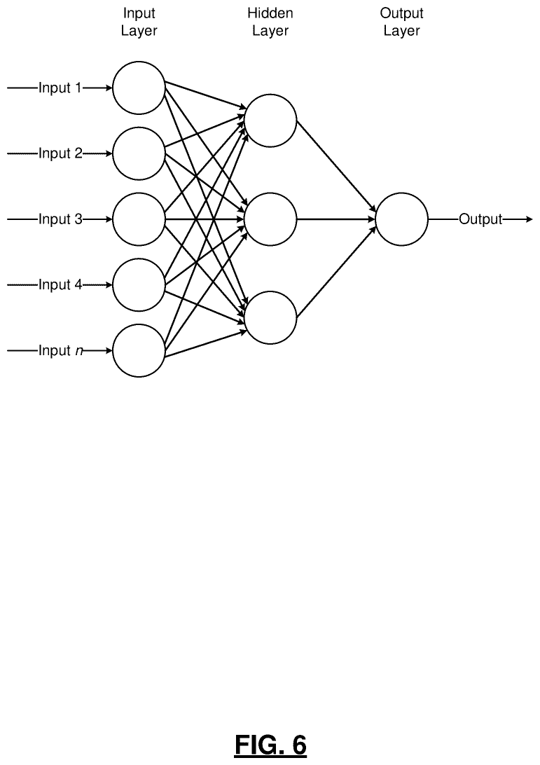

FIG. 6 is a graphical representation of an example neural network with one hidden layer for implementing the machine learning module. As illustrated in FIG. 6, the neural network may one or more intermediate layers—referred to as hidden layers—between the input layer and the output layer. The neural network of FIG. 6 may be referred to as a multilayer perceptron. Each node of a hidden layer may be connected to one or more nodes of the previous layer and receive inputs from the connected nodes of the previous layer—such as the value of the node of the previous layer multiplied by a weight (xₙwₙ) or the value of the node of the previous layer multiplied by a weight with a bias added (xₙwₙ+bₙ). Each node of the hidden layer may then function in a manner analogous to the node of the output layer of FIG. 5 by summing the inputs, feeding the summed inputs into an activation function, and feeding the output of the activation function into one or more nodes of the next layer. Similarly, the nodes of the output layer function in a manner analogous to the node of the output layer of FIG. 5. For example, the nodes of the output layer may receive the outputs of the nodes of the previous layer (multiplied by a weight and/or with a bias added as desired) as inputs, sum the received inputs, feed the summed inputs to an activation function, and output the result of the activation function as an output of the neural network.

In various implementations, the neural network may have any number of hidden layers. In various implementations, each node of a previous layer may be connected to any number of nodes of a next layer. For example, as shown in FIG. 6, each node of the previous layer may be connected to each node of the next layer. Such a neural network may be referred to as a fully-connected neural network. In various implementations, each layer of the neural network may have any number of nodes. In various implementations, a neural network with no hidden layers may function as a linear classifier and be suitable for representing linearly separable decisions or functions. In various implementations, neural networks with one hidden layer may be suitable for performing continuous mapping from one finite space to another. In various implementations, neural networks with two hidden layers may be suitable for approximating any smooth mapping to any level of accuracy.

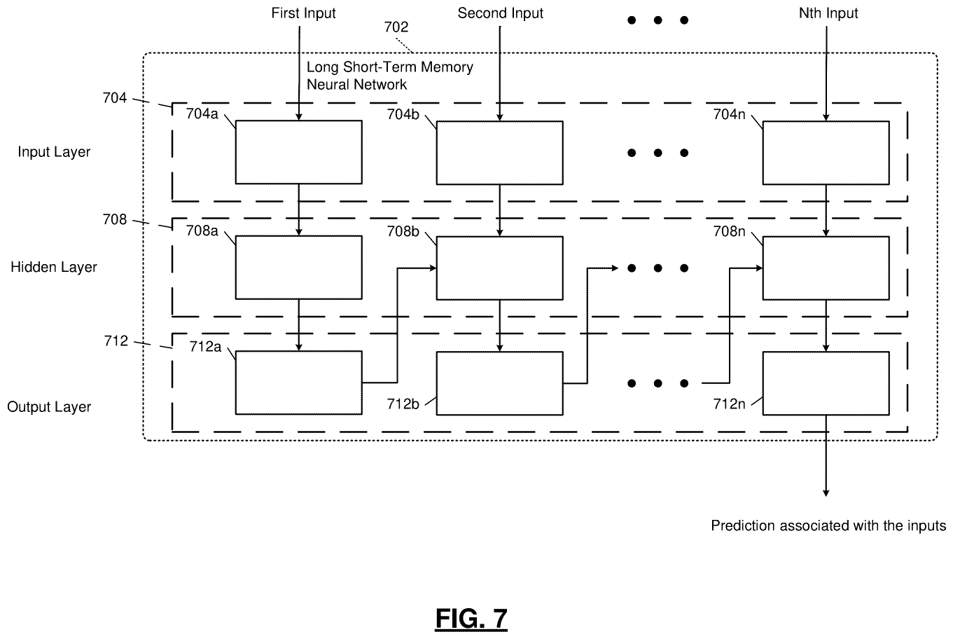

FIG. 7 is a functional block diagram of an example neural network 702 that can be used to produce a predictive model. In some implementations, the neural network 702 can be a long short-term memory (LSTM) neural network. In some implementations, the neural network 702 can be a recurrent neural network (RNN). The example neural network 702 may be used to implement the machine learning as described herein, and various implementations may use other types of machine learning networks. The neural network 702 includes an input layer 704, a hidden layer 708, and an output layer 712. The input layer 704 includes inputs 704a, 704b . . . 704n. The hidden layer 708 includes neurons 708a, 708b . . . 708n. The output layer 712 includes outputs 712a, 712b . . . 712n.

Each neuron of the hidden layer 708 receives an input from the input layer 704 and outputs a value to the corresponding output in the output layer 712. For example, the neuron 708a receives an input from the input 704a and outputs a value to the output 712a. Each neuron, other than the neuron 708a, also receives an output of a previous neuron as an input. For example, the neuron 708b receives inputs from the input 704b and the output 712a. In this way the output of each neuron is fed forward to the next neuron in the hidden layer 708. The last output 712n in the output layer 712 outputs a probability associated with the inputs 704a -704n. Although the input layer 704, the hidden layer 708, and the output layer 712 are depicted as each including three elements, each layer may contain any number of elements. Neurons can include one or more adjustable parameters, weights, rules, criteria, or the like.

In various implementations, each layer of the neural network 702 must include the same number of elements as each of the other layers of the neural network 702. For example, training features may be processed to create the inputs 704a-704n.

The inputs 704a-704n can include data features (binary, vectors, factors or the like) stored in the storage device 110. The features can be provided to neurons 708a-708n for analysis and connections between the known facts. The neurons 708a-708n, upon finding connections, provides the potential connections as outputs to the output layer 712.

In some examples, a convolutional neural network may be implemented. Similar to neural networks, convolutional neural networks include an input layer, a hidden layer, and an output layer. However, in a convolutional neural network, the output layer includes one fewer output than the number of neurons in the hidden layer and each neuron is connected to each output. Additionally, each input in the input layer is connected to each neuron in the hidden layer. In other words, input 704a is connected to each of neurons 708a, 708b . . . 708n.

The initial model that is built can be built in a secure environment using health data relating to patients. The initial model can then be refined based on feedback with a computing system that also is in a secure environment. The health data, e.g., the patient name, drug name, dosing data, and other prescription information, is always within a secure computing environment and not communicated out to a public data base and subjected to a third-party artificial intelligence. The secure computing system mitigates the risk of working with protected health data and other types of high-risk data, e.g., personal identifying information, and/or state protected data. In an example, the secure computing system is a mainframe computer with limited connection to external systems. In an example, the computing system is a private cloud environment that provides high-performance, secure, and flexible computing environments enabling the analysis of sensitive datasets restricted by federal privacy laws, proprietary access agreements, or confidentiality requirements. A private cloud environment can provide creation of any combination of network, CPU, RAM, and storage components into resource groups that can be used to build multi-tenant, multi-site infrastructure as a service.

### Workflow

An analyst user can create a machine learning scheme (or workflow) via a graphical scheme creation user interface. Using a graphical user interface to create machine learning schemes lowers the amount of technical knowledge required of the user creating the workflow. The graphical user interface is also connected to (or in communication with) a repository of previously used, created, and/or saved schemes. This allows a user to reuse or repurpose elements of previously created and/or saved schemes.

In some implementations, a machine learning scheme has one or more elements. In some implementations, scheme elements include one or more data models, one or more data features, one or more feature assignments, one or more tasks, and/or configuration data. In some implementations, data models are stored in a database accessible via the graphical user interface. In some implementations, a feature is a set of data interpreted by the data models to generate a prediction and/or analysis data. In some implementations, a feature can be mapped (or assigned) to different data sets. For example, feature A is mapped to a data set of patients from the United States in scheme A, and in scheme B, feature A is mapped to a data set of patients of company C. In some implementations, values assigned to the features must be generated, calculated, and/or determined as part of the scheme before the values can be mapped to the features. In some implementations, feature mapping includes a parsing algorithm for isolating values from a data source such as a database or file for mapping to a feature. In some implementations, feature mapping includes the location of a value in a data source and/or file (for example a data tag, or a column and/or row corresponding to the location of a value, a position of a value in an array or CSV file, etc.) In some implementations, machine learning schemes include one or more tasks such as data set loading, feature generation, loading features into the one or more data models, generating a population from the data set, generating a prediction or other analysis output from the data models, loading configuration information, and/or post-processing statistical analysis. In some implementations, the different settings and elements are saved as configuration information (such as feature mapping and imputation).

In some implementations, implementing the scheme includes executing the tasks of the scheme resulting in predictions from the one or more data models, statistics and/or analysis of the data. In some implementations, one or more tasks are executed in parallel (for example, feature generation tasks and/or data model analysis if multiple data models are used by the scheme).

To create a new scheme, a user modifies elements of a previously saved scheme, or creates new elements without a template or previously created element. In some implementations, a scheme includes several elements that are required (such as features and/or data models). In some implementations, a new scheme includes new elements (i.e., not previously used in another scheme). In some implementations, one or more scheme elements are previously saved elements from one or more previously saved schemes. For example, new scheme G can include data models created for scheme A, tasks from scheme B, and/or feature assignments from scheme C. In some implementations, only one or two elements of the new scheme differ from the elements of a previous scheme. In some implementations, modifying the scheme includes adding or removing at least one data model from the scheme. In some implementations, modifying the scheme includes adding or removing a feature. In some implementations, modifying the scheme includes mapping a feature to a different set of values. In some implementations, modifying the scheme includes adding, removing, or changing a task. In some implementations, previously saved scheme elements are shown as available options via a drop down menu, suggestions, or autocomplete options based on user inputs. In some implementations, saving a new scheme requires authorization approval before a new scheme can be saved to the scheme data storage or before a scheme can be saved as a new version of a previously saved scheme via versioning software.

### Block Diagram

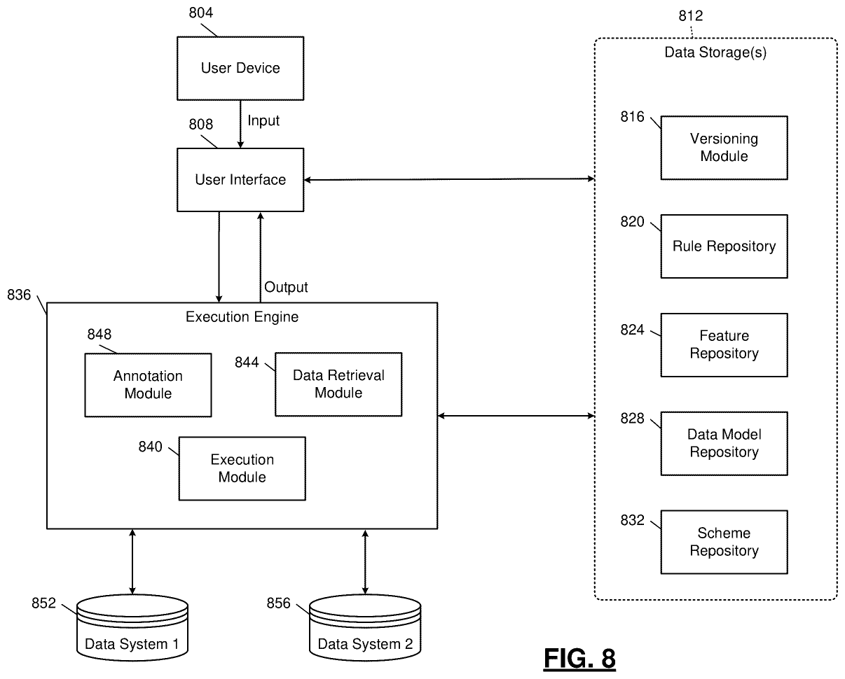

FIG. 8 is a block diagram of an example system that may be used to generate and implement reusable workflows. User device 804 (for example, a computer system with a display device, processor, and one or more input devices) displays user interface 808 and detects user input. User device 804 and user interface 808 receive user input corresponding to the creation and implementation of machine learning schemes. User interface 808 transmits scheme modifications to data storage 812. Data storage 812 includes versioning module 816, rule repository 820, feature repository 824, data model repository 828, and scheme repository 832. Versioning module 816 manages versions of the scheme as changes are made to the scheme. Rule repository 820 saves rules used in the workflow (for example to generate a population or for post processing tasks). Feature repository 824 stores features used by data models. Data model repository 828 saves data models used by the workflow. Scheme repository 832 saves schemes created by user interface 808. In some implementations, user interface 808 loads schemes, rules, features, and/or data models from data storage 812.

User interface 808 and data storage 812 communicate with execution engine 836, which implements workflows created by user interface 808 and/or stored in data storage 812. Execution engine 836 includes data retrieval module 844, execution module 840, and annotation module 848. In some implementations, execution engine 836 transmits the output data set generated by the executed workflow to user interface 808 for display. In some implementations, the output of execution engine 836 is transmitted to multiple interfaces on multiple devices. In some implementations, execution engine 836 transmits output to a server accessible via user device 804 via a web portal. In some implementations, annotation module 848 converts and/or saves output generated by execution module 840 to data storage 812, data system 852 and/or data system 856. In some implementations, annotation module 848, generates and/or saves logs, metadata, time stamps, user access records, etc. associated with the implementation of a workflow.

In some implementations, execution module 840 implements the workflow scheme created by user interface 808. In some implementations, execution module 840 implements a workflow loaded from scheme repository 832. In some implementations, execution module 840 performs tasks associated with the scheme. In some implementations, execution module 840 generates analysis or predictions using one or more data models associated with the scheme.

In some implementations, data retrieval module 844 retrieves data from data storage 812, (such as rules, features, data models, and/or schemes) data system 852, and data system 856. In some implementations, data system 852 and data system 856 store data assigned to the features used by one or more data models to generate predictions and/or analysis. In some implementations, data system 852 and data system 856 include one or more servers and/or local memory hardware. In some implementations, data system 852 and data system 856 are remote from execution engine 836 and data storage 812. In some implementations, data system 852 and data system 856 are located at a centralized location. In some implementations, data system 852 and data system 856 include multiple sub-systems dispersed over multiple locations, servers, and/or memory hardware. For example, in some implementations, data system 852 includes patient records stored at a hospital, a pharmacy, and/or a primary care physician office.

### Flowchart

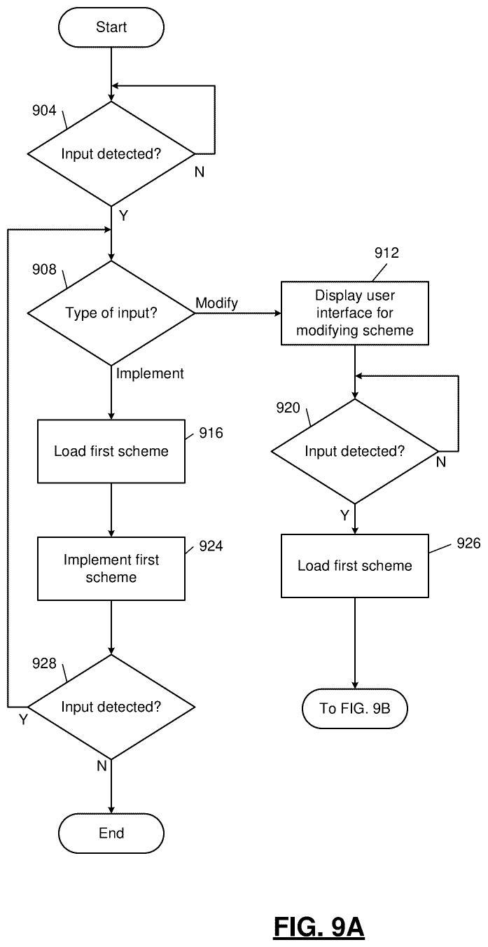

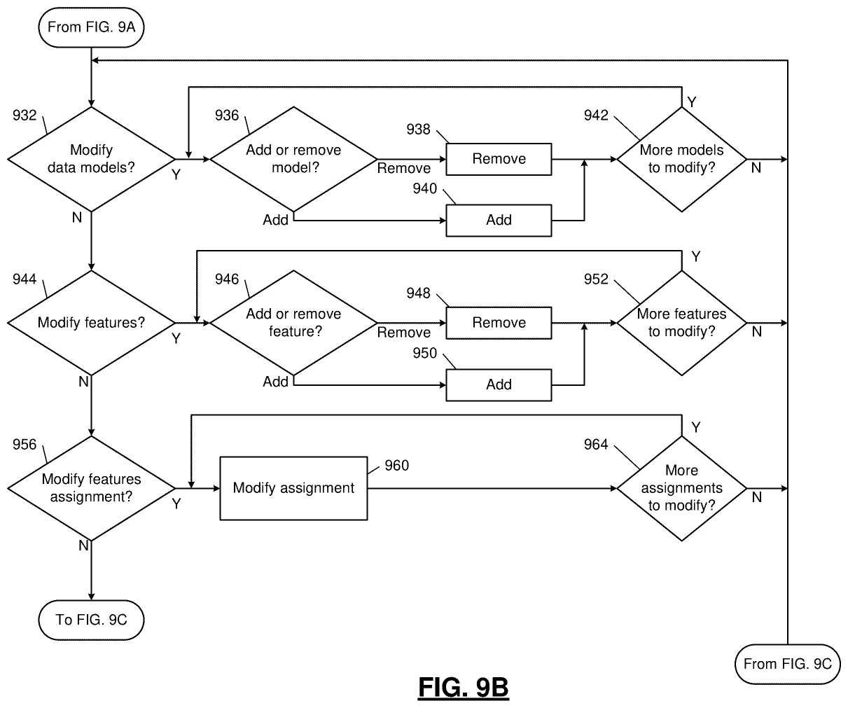

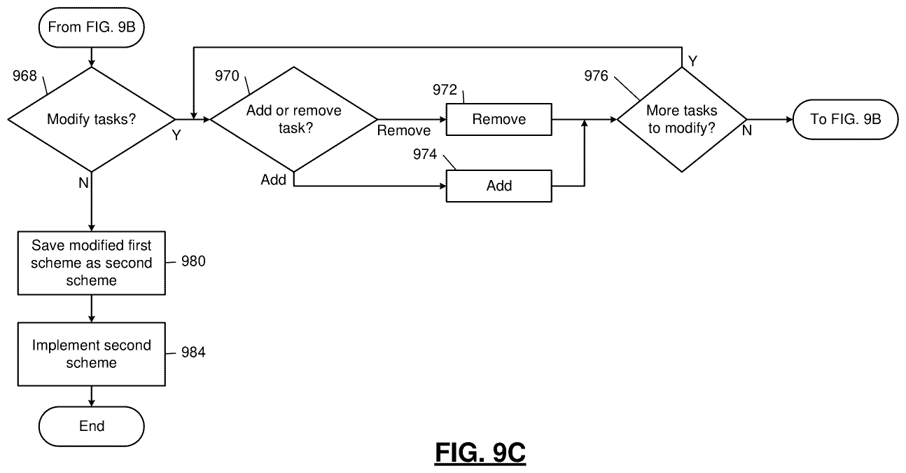

FIGS. 9A-9C are a flowchart of an example reusable workflow generation and execution method. The method begins at 904 where control waits for a user input. If no user input is detected, control remains at 904. If input is detected, control transfers to 908. At 908, control determines whether the detected input corresponds to a request to implement a saved scheme or modify a saved scheme. If the input corresponds to a request to modify a scheme, control transfers to 912. If the input corresponds to a request to implement a template, control transfers to 916. At 916, control loads a first scheme and control continues to 924. At 924, control implements the first scheme. At 928, control determines whether additional input is detected. If no input is detected, control ends. If input is detected, control transfers to 908. At 912, control displays a user interface for modifying a scheme, and continues to 920. At 920, control determines whether input as been detected. If no input is detected, control remains at 920. If input is detected, control transfers to 926 and loads the first scheme.

Next, control continues to 932 and determines whether one or more data models associated with the scheme are to be modified. If there are no data models that require modification, control transfers to 944. If there are data models that require modification, control transfers to 936 and determines whether a data model is to be added or removed. If a model is to be added, control transfers to 940. If a data model requires removal, control transfers 938. After adding or removing a data model as determined at 936, control continues to 942 and determines whether additional models require modification. If true, control transfers to 936. If false, control transfers to 932.

At 944, control determines whether features of the scheme require modification. If true, control transfers to 946. If false, control transfers to 956. At 946, control determines whether to add or remove a feature. If a feature requires addition to the scheme, control transfers to 948. If a feature is to be removed, control transfers to 950. After adding or removing a feature, control continues to 952 and determines whether additional features require modification. If true, control transfers to 946. If false, control transfers to 932.

At 956 control determines whether feature assignments of the scheme require modification (i.e., modification of which values are assigned to the features). If no feature assignments require modification, control transfers to 968. If control determines that a feature assignment requires modification, control transfers to 960 and modifies the assignment. After modifying the assignment at 960, control continues to 964 and determines whether more assignments require modification. If no assignments require modification, control transfers to 932. If additional assignments require modification, control transfers back to 960.

After transferring to 968, control determines whether a task of the scheme requires modification. If no task requires modification, control transfers to 980. If a task requires modification, control transfers to 970 and determines whether to add or remove a task from the scheme. If a task is to be added, control transfers to 972. If a task is to be removed, control transfers to 974. After adding or removing task as necessary, control transfers to 976 and determines whether there are additional tasks to modify. If control determines there are additional tasks, control transfers to 970. If there are no additional tasks to modify control transfers to 932. At 980, control saves the modified first scheme as a second scheme and continues to 984. At 984, control implements the second scheme and control ends.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-5020 (also known as the WIFI wireless networking standard) and IEEE Standard 802.3-5018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A method comprising:
loading a first scheme from a machine learning scheme repository, wherein the first scheme includes:
a set of data models for evaluating a set of features including a first feature, an assignment of a first set of values to the first feature; and
a first set of tasks reliant on the set of data models and the set of features;
in response to detecting a first set of user inputs corresponding to a request to implement the first scheme, implementing the first scheme by executing tasks of the first set of tasks;
in response to detecting a second set of user inputs, transforming a user interface to display a first set of user interface elements for modifying a saved scheme; and
in response to detecting a third set of user inputs corresponding to the first set of user interface elements:
loading the first scheme;
displaying the first scheme via the first set of user interface elements;
modifying the first scheme according to the third set of user inputs, wherein:
modifying the first scheme includes modifying the first set of tasks and saving the modified first set of tasks as a second set of tasks; and
the second set of tasks includes a task for generating an output data set via the set of data models;
saving the modified first scheme as a second scheme in the machine learning scheme repository;
implementing the second scheme by executing tasks of a second set of tasks; and
outputting the output data set.

2. The method of claim 1, wherein a plurality of tasks from the first set of tasks are completed in parallel.

3. The method of claim 1, wherein saving the second scheme is performed in response to receiving an indication of authorization.

4. The method of claim 1, wherein the first set of tasks includes at least one of:
a task for generating a population;
a task for generating the set of features;
a task for loading the set of features;
a task for loading a set of configuration information;
a task for performing a set of imputation actions for substituting missing data;
a task for generating a set of predictions using the set of data models; or
a task for generating a set of statistics about the set of predictions and the set of features.

5. The method of claim 4, wherein generating features includes determining one or more values.

6. The method of claim 4, wherein the set of configuration information includes mapping the set of features to the first set of values in the set of data models.

7. The method of claim 1, wherein modifying the first scheme includes at least one of:
adding at least a first data model to the set of data models;
removing at least a second data model from the set of data models;
adding at least a second feature to the set of features;
removing at least a third feature from the set of features;
assigning a second set of values to the first feature;
adding at least a first task to the first set of tasks; or
removing at least a second task from the first set of tasks.

8. The method of claim 1, wherein the second set of tasks is different from the first set of tasks.

9. The method of claim 1, wherein outputting the output data set includes displaying the output data set via a second set of user interface elements.

10. The method of claim 1, wherein the assignment of the first set of values to the first feature includes at least one of:
a location of the first set of values in a data source;
a parsing algorithm for identifying the first set of values; or
a first data field in the data source.

11. A computer system comprising:
memory hardware configured to store instructions; and
processor hardware configured to execute the instructions, wherein the instructions include:
loading a first scheme from a machine learning scheme repository, wherein the first scheme includes:
a set of data models for evaluating a set of features including a first feature, an assignment of a first set of values to the first feature; and
a first set of tasks reliant on the set of data models and the set of features;
in response to detecting a first set of user inputs corresponding to a request to implement the first scheme, implementing the first scheme by executing tasks of the first set of tasks;
in response to detecting a second set of user inputs, transforming a user interface to display a first set of user interface elements for modifying a saved scheme; and
in response to detecting a third set of user inputs corresponding to the first set of user interface elements:
loading the first scheme;
displaying the first scheme via the first set of user interface elements;
modifying the first scheme according to the third set of user inputs, wherein:
modifying the first scheme includes modifying the first set of tasks and saving the modified first set of tasks as a second set of tasks; and
the second set of tasks includes a task for generating an output data set via the set of data models;
saving the modified first scheme as a second scheme in the machine learning scheme repository;
implementing the second scheme by executing tasks of a second set of tasks; and
outputting the output data set.

12. The computer system of claim 11, wherein:
a plurality of tasks from the first set of tasks are completed in parallel; and
saving the second scheme is performed in response to receiving an indication of authorization.

13. The computer system of claim 11, wherein the first set of tasks includes at least one of:
a task for generating a population;
a task for generating the set of features;
a task for loading the set of features;
a task for loading a set of configuration information;
a task for performing a set of imputation actions for substituting missing data;
a task for generating a set of predictions using the set of data models; or
a task for generating a set of statistics about the set of predictions and the set of features.

14. The computer system of claim 13, wherein:
generating features includes determining one or more values;
the set of configuration information includes mapping the set of features to the first set of values in the set of data models; and
outputting the output data set includes displaying the output data set via a second set of user interface elements.

15. The computer system of claim 11, wherein modifying the first scheme includes at least one of:
adding at least a first data model to the set of data models;
removing at least a second data model from the set of data models;
adding at least a second feature to the set of features;
removing at least a third feature from the set of features;
assigning a second set of values to the first feature;
adding at least a first task to the first set of tasks; or
removing at least a second task from the first set of tasks.

16. A non-transitory computer-readable medium comprising processor-executable instructions, the instructions including:
loading a first scheme from a machine learning scheme repository, wherein the first scheme includes:
a set of data models for evaluating a set of features including a first feature, an assignment of a first set of values to the first feature; and
a first set of tasks reliant on the set of data models and the set of features;
in response to detecting a first set of user inputs corresponding to a request to implement the first scheme, implementing the first scheme by executing tasks of the first set of tasks;
in response to detecting a second set of user inputs, transforming a user interface to display a first set of user interface elements for modifying a saved scheme; and
in response to detecting a third set of user inputs corresponding to the first set of user interface elements:
loading the first scheme;
displaying the first scheme via the first set of user interface elements;
modifying the first scheme according to the third set of user inputs, wherein:
modifying the first scheme includes modifying the first set of tasks and saving the modified first set of tasks as a second set of tasks; and
the second set of tasks includes a task for generating an output data set via the set of data models;
saving the modified first scheme as a second scheme in the machine learning scheme repository;
implementing the second scheme by executing tasks of a second set of tasks; and
outputting the output data set.

17. The non-transitory computer-readable medium of claim 16, wherein:
a plurality of tasks from the first set of tasks are completed in parallel; and
saving the second scheme is performed in response to receiving an indication of authorization.

18. The non-transitory computer-readable medium of claim 16, wherein the first set of tasks includes at least one of:
a task for generating a population;
a task for generating the set of features;
a task for loading the set of features;
a task for loading a set of configuration information;
a task for performing a set of imputation actions for substituting missing data;
a task for generating a set of predictions using the set of data models; or
a task for generating a set of statistics about the set of predictions and the set of features.

19. The non-transitory computer-readable medium of claim 18, wherein:
generating features includes determining one or more values;
the set of configuration information includes mapping the set of features to the first set of values in the set of data models; and
outputting the output data set includes displaying the output data set via a second set of user interface elements.

20. The non-transitory computer-readable medium of claim 16, wherein modifying the first scheme includes at least one of:
adding at least a first data model to the set of data models;
removing at least a second data model from the set of data models;
adding at least a second feature to the set of features;
removing at least a third feature from the set of features;
assigning a second set of values to the first feature;
adding at least a first task to the first set of tasks; or
removing at least a second task from the first set of tasks.
